(19) United States
(12) Patent Application Publication
(10) Pub. No.: US 2025/0298862 A1
(43) Pub. Date: Sep. 25, 2025

(54) METHODS AND SYSTEMS FOR ACCELERATING MULTI-STAGED MACHINE LEARNING PIPELINES WITHOUT DATA CONVERTER

(71) Applicant: Hewlett Packard Enterprise Development LP, Spring, TX (US)

(72) Inventors: Luca Buonanno, Milpitas, CA (US); Giacomo Pedretti, Verbania (IT); James Ignowski, Ft. Collins, CO (US); Todd Richmond, Ft. Collins, CO (US); Aishwarya Natarajan, Milpitas, CA (US)

(21) Appl. No.: 18/790,748

(22) Filed: Jul. 31, 2024

Related U.S. Application Data
(60) Provisional application No. 63/567,327, filed on Mar. 19, 2024.

(51) Int. Cl. G06F 17/16

(52) U.S. Cl. CPC G06F 17/16

(57) ABSTRACT

A device that includes a first circuit, an analog content addressable memory (ACAM), and a result analyzer is disclosed. The first circuit can be programmed with a matrix. The first circuit can be configured to receive an input vector comprising a first set of values; perform a matrix multiplication by multiplying the input vector by the matrix to obtain a matrix multiplication result; and output the matrix multiplication result, where the matrix multiplication result corresponds to a feature vector. The ACAM can be configured to receive the feature vector and perform an operation using the feature vector to obtain a set of output match results. The result analyzer can be configured to output a machine learning algorithm result based on the set of output match results. In some implementations, the matrix multiplication can be performed using a dot product engine of the first circuit.

### CROSS-REFERENCE TO RELATED APPLICATIONS

This application claims the benefit of U.S. Provisional Application No. 63/567,327, filed on Mar. 19, 2024, which application is incorporated herein by reference.

### BACKGROUND

Machine learning algorithms, including neural networks and decision trees, are used in various fields such as data analysis, pattern recognition, and artificial intelligence. These algorithms often require relatively large computational resources, particularly when processing large datasets or performing complex operations in real time or near real time.

Typical implementations of machine learning pipelines can involve multiple stages of data conversion between analog and digital domains. This conversion typically includes analog-to-digital conversion (ADC) of input data and digital-to-analog conversion (DAC) of processed data. These conversion steps can at least partially cause latency, consume substantial power, and potentially result in loss of information due to quantization errors.

### BRIEF DESCRIPTION OF THE DRAWINGS

Aspects of the present disclosure are best understood from the following detailed description when read with the accompanying figures.

FIG. 1 illustrates an example accelerator, according to some implementations.

FIG. 2 illustrates an example implementation of a first circuit, according to some implementations.

FIG. 3 illustrates an example implementation of a first circuit, according to some implementations.

FIG. 4 is a block diagram of a computing system, according to some implementations.

FIG. 5 is a diagram of an acceleration method, according to some implementations.

Corresponding numerals and symbols in the different figures generally refer to corresponding parts unless otherwise indicated. The figures are drawn to clearly illustrate the relevant aspects of the disclosure and are not necessarily drawn to scale.

### DESCRIPTION

The following disclosure provides examples for implementing different features. Specific examples of components and arrangements are described below to simplify the present disclosure. These are merely examples and are not intended to be limiting.

The following disclosure outlines features of several examples so that those skilled in the art may better understand the aspects of the present disclosure. Various modifications and combinations of the examples, as well as other examples, will be apparent to persons skilled in the art upon reference to the description. It is intended that the appended claims encompass any such modifications.

The present disclosure utilizes analog content addressable memories (ACAMs) and dot product engines (DPEs). In some implementations, an ACAM is a circuit that can be used for storing a word as a list of ranges and returning a match result when all input voltages fall within a programmed acceptable range.

The DPE array can include programmable elements that have adjustable values such as conductances or resistances. While memristors are one example of such programmable elements, the DPE array can also be implemented using various other technologies, including multi-bit flash memory cells, ReRAM, PCRAM, MRAM, ECRAM, or other programmable elements. In some implementations, a DPE can be a circuit where, by encoding a matrix entry into conductance of a memory device, matrix vector multiplications can be executed in an analog domain. Matrix vector multiplications may be used in various forms of machine learning algorithm execution (e.g., neural networks), and may require large quantities of computing resources.

The present disclosure describes combination of DPEs and ACAMs for performing dot product, search, and/or other operations, without delay that is typically associated with an intermediate conversion step, e.g., converting analog signals to digital signals or vice versa within the operations between DPEs and ACAMs. The combination of the DPE and the ACAM can be mapped to performing operations related to a machine learning pipeline in the analog domain. The combination of the DPE and the ACAM can deliver a result (e.g., the inferred class) without, for example, performing analog to digital conversion (ADC).

In some implementations of the machine learning pipeline, the DPE can be used for dimensionality reduction techniques and the ACAM for implementing decision tree structures. As an example, the DPE can be used to implement principal component analysis (PCA) and the ACAM can be used to perform inference in a trained decision tree. In some implementations, the DPE can be conditioned to output currents that can be, for example, ACAM voltage inputs after converting the currents to voltages. In some implementations, for example, transimpedance amplifiers (TIAs) can be used for such signal conditioning (e.g., the conversion of the currents output from the DPE to voltages to be input to the ACAM). In some implementations, a pipeline that includes DPEs and ACAMs can be used to accelerate the same or substantially the same workload that could otherwise be executed using traditional computing components, such as memory and/or processors operating with digitized data.

In some implementations, an analog pipeline can be implemented where a non-linear analog stage is added between at least two crossbar arrays. For example, the non-linear circuit input-output relation can be equivalent to a fully connected layer of neurons. Such implementations can be used, for example, to accelerate computing workloads of neural networks. In some implementations, an autoencoder can be used to implement neuron layers, that can be located in the machine learning pipeline in addition to or instead of the PCA. In some implementations, the analog features can be provided to the ACAM to perform, at least in part, classification tasks without an ADC data converter. In some implementations, an accelerator of the present disclosure can reduce power consumption and latency compared to traditional digital implementations by eliminating or substantially reducing the need for intermediate ADC and/or DAC conversions.

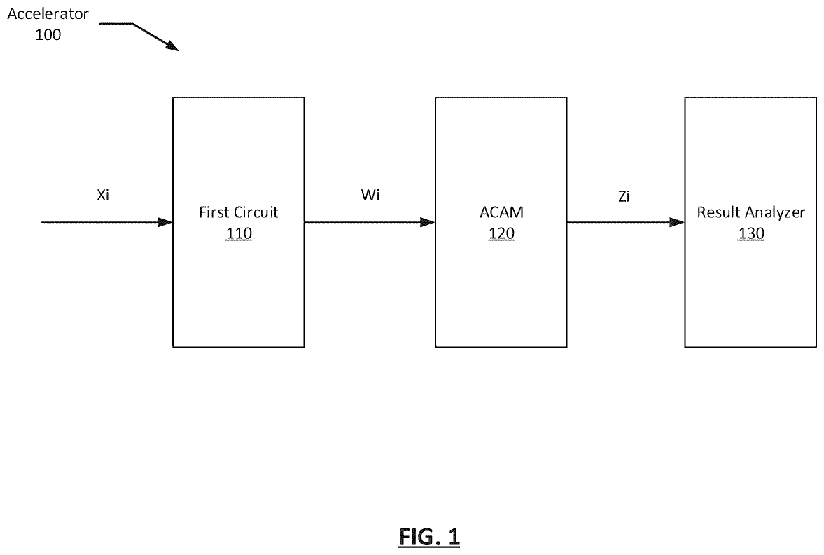

FIG. 1 illustrates an example accelerator 100, according to some implementations. In some implementations, the accelerator 100 can include a first circuit 110, an ACAM 120, and a result analyzer 130.

In some implementations, the first circuit 110 can be a set of analog and/or digital components configured for data processing and dimensionality reduction. In one or more examples, the first circuit 110 may include one or more DPEs and one or more signal processing circuitries. The first circuit 110 can be configured to process analog and/or digital inputs, depending on the specific implementation. The first circuit 110 may include components for dimensionality reduction, such as components for implementing PCA or autoencoding. The first circuit 110 can be configured to receive an input vector Xi comprising a first set of values, perform matrix multiplication using the input vector Xi, and output a matrix multiplication result, which corresponds to a feature vector Wi. The accelerator 100 may be preceded by additional circuitry that performs transformations on input data to generate the input vector Xi in the appropriate form for the first circuit 110.

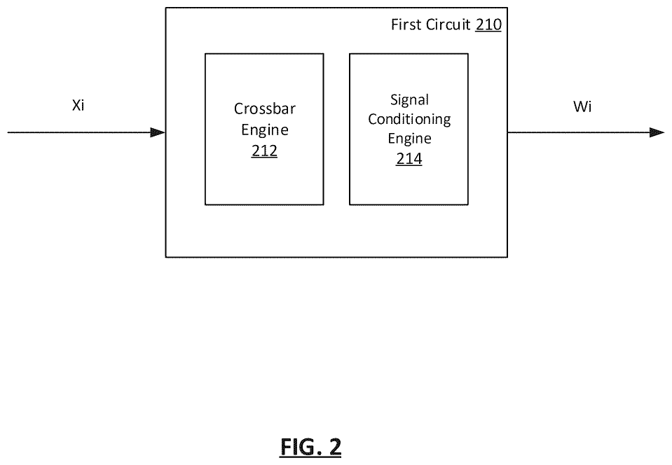

A brief reference is now made to FIG. 2, illustrating an example implementation of the first circuit 210, according to some implementations. The first circuit 210 can include a crossbar engine 212 and a signal conditioning engine 214. The first circuit 210 can receive analog input signals, according to some implementations. In some implementations, the crossbar engine 212 of the first circuit 210 can be configured to perform matrix-vector multiplication in an analog domain by multiplying the input vector Xi comprising a first set of analog values and the matrix comprising a second set of analog values.

As used herein, the phrase “analog domain” may refer to a domain of signal processing and computation where information is represented by relatively continuously variable physical quantities, such as voltage, current, or charge. In the analog domain, values can take on various levels within a given range, as opposed to discrete levels in the digital domain.

In some implementations, input data exists in a raw feature space, which can be conceptualized as a multi-dimensional space (e.g., a Cartesian plane for two-dimensional data) where different classes of data are distributed. In some implementations, the first circuit 110 performs PCA on the input data. As an example, the first circuit 110 can project the data onto a lower-dimensional space while preserving the important variations in the data. In some implementations, the PCA process results in a set of principal components, which are used to transform the original data into a new feature space. In some implementations, the ACAM 120 implements a decision tree structure using the transformed features from the PCA step. In some implementations, the ACAM 120 processes the transformed data through the decision tree structure. In some implementations, the result analyzer 130 may process and interpret the output match results from the ACAM 120 to determine the classification of the input data.

In some implementations, analog input signals can be represented by input vector Xi (which can include input signals X₁, X₂, . . . , Xₘ). The crossbar engine 212 can reduce dimensionality of the input vector signals X₁, X₂, . . . , Xₘ. For example, a PCA score matrix can be precomputed and loaded in the crossbar engine 212 for accelerating the PCA projection task. In some implementations, the crossbar engine 212 can output current signals Y₁, Y₂, . . . , Yₙ (not shown), where n can be equal or not equal to m. For example, m can be greater than n.

Matrix-vector multiplication in the analog domain may start with input representation. As an example, the input vector Xi may be represented as a set of analog voltages or currents, where each element of the input vector Xi corresponds to a distinct analog signal.

In some implementations, weight storage can be performed, e.g., the matrix elements (weights) may be stored as analog values, such as programmable conductances or resistances in a crossbar array structure (e.g., in the crossbar engine 212). Multiplication of each input Xi with weights stored in the crossbar may occur through, e.g., Ohm's law. When a voltage is applied across a resistive element, the resulting current can be proportional to both the applied voltage and the conductance of the element.

Summation of the products may be achieved via application of Kirchhoff's current law. The currents resulting from each multiplication can sum at the output nodes of the crossbar array (e.g., in the crossbar engine 212).

The result of the matrix-vector multiplication may be represented as a set of output currents or voltages Yi, which can be further processed or converted as needed. The matrix-vector multiplication process may allow for parallel computation of all or substantially all elements of the output vector Yi relatively simultaneously, providing higher speed and energy efficiency in some implementations.

In some implementations, the signal conditioning engine 214 transforms input currents Y₁, Y₂, . . . , Yₙ (e.g., of the vector of currents Yᵢ output from the crossbar engine 212) to voltages representing a feature vector Wi, having signals W₁, W₂, . . . , Wₚ. The signal conditioning engine 214 can be a transimpedance amplifier (TIA), an integrator, and the like. In some implementations, W₁, W₂, . . . , Wₚ represent analog ACAM inputs in a projected space; such W₁, W₂, . . . , Wₚ can represent features.

In some implementations, W vector having signals W₁, W₂, . . . , Wₚ can be calculated using Equation (1).

$$W = ( X \cdot M \cdot {R}_{F} ) - {v}_{bias} , \qquad ( 1 )$$

where X is the input vector having signals X₁, X₂, . . . , Xₘ; M is a conductance matrix of the DPE engine (e.g., the DPE engine which can be the crossbar engine 212); RF is a feedback resistance of the signal conditioning engine 214; and vbias is a bias voltage of the signal conditioning engine 214.

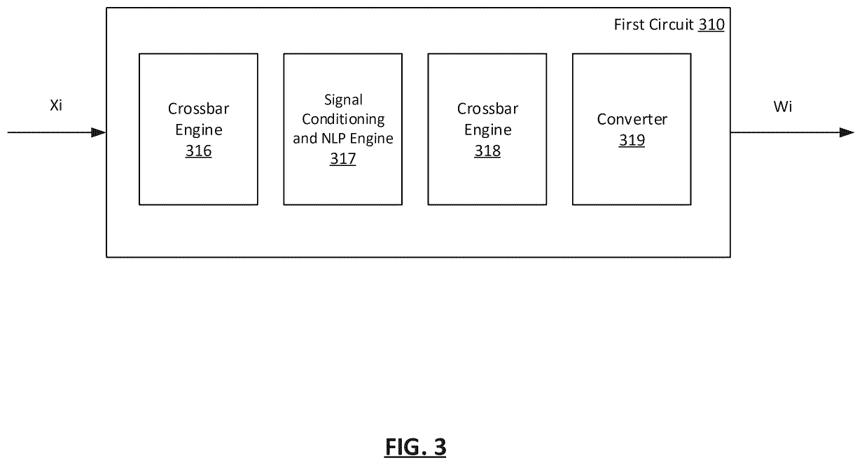

A brief reference is now made to FIG. 3, illustrating another example implementation of the first circuit 210, which has two crossbar engines 316 and 318, according to some implementations. The first circuit 310 can include a signal conditioning and NLP engine 317, which can include, e.g., a rectified linear unit. The signal conditioning and NLP engine 317 processes signal conditioning and nonlinear function. In some implementations, neural network weights of the autoencoder can be precomputed and encoded into layers of the crossbar engines 316 and 318.

The first circuit 310 can be configured to receive an input vector Xi, which can be analog or digital; perform several stages of matrix multiplication and data transformation; and output a processed feature vector Wi. In some implementations, the crossbar engine 316 can be configured for implementing the initial matrix multiplication operation and transforming input signals into a high-dimensional space. In some implementations, the signal conditioning and NLP engine 317 can be configured for receiving the output from the first crossbar engine 316; transforming the signals, e.g., from one representation to another representation; applying appropriate non-linear transformations; and preparing the signals for the next stage of processing.

In some implementations, the crossbar engine 318 is a second crossbar engine that can be configured for performing additional matrix multiplications on the conditioned signals; implementing transformations or further dimensionality adjustments (e.g., performing dimensionality reduction or feature extraction). In some implementations, the converter 319 which can be a converter of current signals received from the crossbar engine 318 to the voltage signals, which are input into subsequent ACAM 120.

In some implementations, the input vector Xi is input to the first circuit 310, the first crossbar engine 316 performs initial matrix multiplication, the signal conditioning and NLP engine 317 processes the output of the first crossbar engine, the second crossbar engine 318 performs additional transformations, the converter 319 performs appropriate signal adjustments, and the processed feature vector Wi is output by the first circuit 310. The accelerator 100 can include an implementation of an autoencoder and a decision tree, according to some implementations. In some implementations, the autoencoder can be implemented, at least in part, by the first circuit 310.

In some implementations, data projection is performed using an autoencoder (e.g., the first circuit 310). According to some implementations, the data projection can deliver more efficient separation boundaries among classes. In some implementations, through application of weights and nonlinear functions of the signal conditioning and NLP engine 317, a number of relevant features (in a feature space) can become smaller (corresponding to, e.g., transformed features of the feature vector Wi). Thus, the autoencoder can provide a dimensionality reduction, which can be mapped to a plurality of the crossbar engines 316, 318 (e.g., the DPEs) and non-linear processing engine (which can be, for example, the signal conditioning and NLP engine 317).

In some implementations, the crossbar engine 316 transforms analog inputs X₁, X₂, . . . , Xₘ to high dimensional space. For example, the crossbar engine 316 can transform the analog inputs X₁, X₂, . . . , Xₘ to current signals Y₁, Y₂, . . . , Yₙ (not shown). In some implementations, the crossbar engine 316 can output current signals Y₁, Y₂, . . . , Yₙ, where n can be equal or not equal to m. For example, n can be greater than m.

In some implementations, the signal conditioning and nonlinear transformation engine 317 transforms the input currents or charges Y₁, Y₂, . . . , Yₙ to voltages Q₁, Q₂, . . . , Qⱼ (not shown). The signal conditioning and nonlinear transformation engine 317 of the autoencoder can perform a transformation of the charge to voltage and execute nonlinear transformation to output voltages Q₁, Q₂, . . . , Qⱼ. In some implementations, Q₁, Q₂, . . . , Qⱼ can represent analog ACAM inputs in a projected space. In some implementations, the signal conditioning and NLP engine 317 can output the signals Q₁, Q₂, . . . , Qⱼ, where n can be equal or not equal to j.

In some implementations, the crossbar engine 318 transforms input signals Q₁, Q₂, . . . , Qⱼ to signals representing a feature vector Wi, having features W₁, W₂, . . . , Wₚ. In some implementations, W₁, W₂, . . . , Wₚ represent analog ACAM inputs in a projected space; such W₁, W₂, . . . , Wₚ can represent features.

In some implementations, W vector having signals W₁, W₂, . . . , Wₚ can be calculated using Equation (1), where X is the input vector having signals X₁, X₂, . . . , Xₘ; M is a conductance matrix of the crossbar engine 318 (e.g., the DPE engine); R_{F} is a feedback resistance of the signal conditioning and NLP engine 317; and v_{bias} is a bias voltage of the signal conditioning and nonlinear transformation engine 317. In some implementations, the Q₁, Q₂, . . . , Qⱼ signals are provided to the crossbar engine 318 to perform transformation of the Q₁, Q₂, . . . , Qⱼ signals into the low dimensional space. For example, the crossbar engine 318 can output signals W₁, W₂, . . . , Wₚ; such W₁, W₂, . . . , Wₚ can represent features. In some implementations, p can be equal or not equal to j. For example, j can be greater than p.

While FIG. 3 illustrates an implementation of the first circuit 310 with two crossbar engines 316 and 318, this configuration is provided as an exemplary embodiment. The present disclosure is not limited to such specific arrangement. In some implementations, the first circuit 310 may incorporate any number of crossbar engines to implement various layers of the autoencoder, depending on the complexity of the desired autoencoder architecture and the specific requirements of the application.

In some implementations, the first circuit 310 can use the converter 319 that can convert the current signals received from the crossbar engine 318 into the feature vector Wi including signals W₁, W₂, . . . , Wₚ. The converter 319 can be an electronic device having a voltage-to-current conversion circuit that transforms the incoming voltage signals into corresponding current signals. Such conversion process is achieved through the utilization of resistors and operational amplifiers, providing relatively accurate and reliable signal conversion. In some implementations, the converter 319 incorporates a feedback circuit to regulate the output current levels, improving the stability and consistency of the converted signals. In some implementations, digital signal processing algorithms are implemented in the converter 319 to improve the conversion efficiency and reduce signal distortion, resulting in high-fidelity current signal outputs.

Returning to FIG. 1, the accelerator 100 also includes the ACAM 120 and a result analyzer 130, which work in conjunction with the first circuit 110 to perform the accelerated machine learning operations. In some implementations, the ACAM 120 can be a memory circuit configured to perform parallel search operations and pattern matching in the analog domain. As an example, the ACAM 120 can be the memory circuit configured to compare input search data against stored data and return matching results. In some implementations, the ACAM 120 can incorporate or be used to implement logic for executing a decision tree. The ACAM 120 can be configured to receive the feature vector Wi from the first circuit 110, perform operations using the feature vector Wi and a transfer function corresponding to a decision tree, and generate a set of output match results Zi. In some examples, the ACAM 120 allows for efficient implementation of classification tasks in an analog domain without the need for analog-to-digital conversion, which may reduce power consumption and latency.

As shown in FIG. 1, the input vector Xi is input into the first circuit 110; the first circuit 110 outputs the feature vector Wi to the ACAM 120; the ACAM 120 processes the feature vector Wi and produces the output match results Zi; and the result analyzer 130 receives the output match results Zi and determines one or more classifications. In some implementations, the ACAM 120 can be more compact and energy-efficient compared to traditional devices executing machine learning operations. The ACAM 120 includes ACAM cells, search lines SL, and match lines ML. The ACAM cells can be arranged in subsets (e.g., in rows and columns). For example, the ACAM 120 may have M rows and N columns.

The search lines SL may be arranged along and correspond to the columns of the ACAM cells. The match lines ML may be arranged along and correspond to the rows of the ACAM cells. Using the ACAM circuitry, the Wi vector can be compared to the values representing a portion of a decision tree stored in the ACAM. A match line in the ACAM determines whether a match between search data and stored data in memory cells occurs. The match line remains activated when a match is found, indicating that an input value matches values and/or value ranges stored in one or more ACAM cells of the ACAM 120. Operating in parallel, the match line may provide fast content-based searches across multiple cells simultaneously, potentially improving execution of a decision tree implemented, at least in part, using the ACAM 120.

In some implementations, the ACAM 120 can be a six transistor, two memristor (6T2M) ACAM. The match line of the ACAM 120 may indicate a match when an input data line voltage is between an upper and lower bound for an input data line voltage set, at least in part, by the memristors.

In some implementations, the memory cells in the ACAM 120 are pre-charged to an initial voltage. When an input voltage is applied, it can be compared against upper and lower bounds set by programmable elements within each cell. A match can occur when the input voltage falls within the lower and upper bounds, causing, at least partially, the cell to maintain its charged state. Otherwise, the cell can discharge, indicating a mismatch. In some implementations, the ACAM 120 allows for efficient pattern matching and range comparisons in the analog domain without the need for ADC and/or DAC conversion.

The ACAM 120 operation can be configured through various features. It can implement “don't care” states, where only one bound (upper or lower) is checked, or an “always match” condition when both bounds are set to the “don't care” values. The ACAM 120 can be configured to operate in a clocked mode, where the match line state is evaluated after a specific time interval. The flexibility in configuration of the ACAM 120, combined with the analog matching process, can allow the ACAM 120 to perform decision-making tasks efficiently. In some implementations, the ACAM 120 allows the accelerator 100 to execute machine learning algorithms with the reduced power consumption and latency compared to the traditional digital implementations.

In some implementations, the accelerator 100 can perform dimensionality reduction and classification using a combination of principal component analysis (PCA) and decision tree methods. The first circuit 110 may implement the PCA for dimensionality reduction, while the ACAM 120 may implement the decision tree for classification.

In some implementations, the decision tree structure can be mapped onto the ACAM 120 in the following configuration. Each path from the root to a leaf in the decision tree can be represented as a chain of nodes. Multiple thresholds for a single feature can be combined into one node to increase efficiency. In some implementations, “don't care” nodes are added for features not evaluated in a particular chain. The “don't care” nodes, representing features not relevant to a particular decision path, are implemented by setting the corresponding ACAM cell to match any input value.

Such representation can be rotated 90 degrees and mapped to the rows of the ACAM 120. In some implementations, the columns of the ACAM 120 correspond to the components of the feature vector Wi (e.g., f1, f2, and/or f3). In some implementations, the ACAM cells can store analog values and ranges, allowing for efficient implementation of the decision tree nodes. For example, a node checking if f1<0.2, f3>=0.7, and f2<0.8 can be implemented in a single row of the ACAM 120.

When an input feature vector Wi is applied to the ACAM 120, the ACAM 120 simultaneously compares the input against all decision tree paths, effectively traversing the entire tree in parallel. In some implementations, W₁, W₂, . . . , Wₚ are provided to the ACAM 120 that utilizes a decision tree configuration for classification of the W₁, W₂, . . . , Wₚ signals. In some implementations, a decision tree of the ACAM 120 is trained offline and loaded in the ACAM 120 for accelerating the inference task.

In some implementations, the transfer function of the ACAM 120 ƒ_{ACAM} can be defined by the following Equation (2) that can be used for calculating Zᵢ:

$${Z}_{i} = {f}_{ACAM} ( {W}_{i} , {T}_{low , i} , {T}_{high , i} ) , \qquad ( 2 )$$

where T_{low,i} and T_{high,i} are the sets of thresholds that a given feature value is compared against in a cell of the ACAM 120 as part of implementing the decision tree in the ACAM 120.

In some implementations, the ACAM 120 can transform the analog inputs W₁, W₂, . . . , Wₚ to Z₁, Z₂, . . . , Zₖ signals. In some implementations, the ACAM 120 can output the signals Z₁, Z₂, . . . , Zₖ, where n can be equal or not equal to k. For example, n can be greater than k. The ACAM 120 can utilize a decision tree configuration for classification of the Z₁, Z₂, . . . , Zₖ signals. In some implementations, a decision tree of the ACAM 120 is trained offline and loaded in the ACAM for accelerating the inference task.

In some implementations, the signals Z₁, Z₂, . . . , Zₖ are provided by the ACAM 120 to the result analyzer 130. After the Z₁, Z₂, . . . , Zₖ signals are provided to the SRAM of the result analyzer 130, the SRAM of the result analyzer 130 identifies which winning leaves define the classified output.

In some implementations, the result analyzer 130 is a component of the accelerator 100 configured to process and interpret the output match results from the ACAM 120. In some implementations, the results analyzer 130 may include hardware and/or software components configured to use the output provided from the ACAM to determine one or more results (e.g., inferences, classifications, and the like). As an example, the result analyzer 130 can be configured to transform the match results into meaningful outputs such as classifications, scores, or other application-specific results. In some implementations, the result analyzer 130 can be a class determiner, which can be configured to receive the set of output match results Zi from the ACAM 120, process the output match results Zi, and output at least one class based on the set of output match results Zi. The class determiner can represent a stage of the classification process, during which the ACAM 120 output is translated into class predictions.

In some implementations, the result analyzer 130 can be configured to perform various functions depending on the specific application of the accelerator. As an example, the result analyzer 130 can determine one or more classes based on the set of output match results from the ACAM 120. In some implementations, the result analyzer 130 can generate numerical scores or rankings associated with different categories or outcomes. In some implementations, the result analyzer 130 can produce probability distributions across multiple possible results. In some implementations, the result analyzer 130 can identify patterns or anomalies in the match results. In some implementations, the result analyzer 130 can trigger specific actions or responses based on the analysis of match results.

In some implementations, the result analyzer 130 may aggregate or summarize information from multiple match results, apply post-processing algorithms to refine or contextualize the raw match data received from the ACAM 120, and interface with other system components to provide inputs for further processing or decision making. The result analyzer 130 may be implemented using a combination of hardware and software components, configured for the specific requirements of the accelerator application.

The result analyzer 130 can be a class determiner, which may be a component configured to output one or more classes based on a set of output match results. In some aspects, the class determiner may analyze the output match results from the ACAM 120 to determine which class or classes are indicated. The class determiner may, in some cases, include logic or circuitry to interpret the match results and map them to appropriate classes.

In certain implementations, the class determiner may output a single most likely class. However, in other implementations, it may output multiple classes, potentially with associated confidence scores or probabilities. The class determiner may, in some instances, apply additional processing or rules to the match results before determining the final class outputs.

The result analyzer 130 may be implemented in various ways, such as in hardware, software, firmware, or a combination thereof. In some aspects, the class determiner may be part of a larger system or integrated with other components. The specific functionality and implementation of the class determiner may vary depending on the particular application and requirements of the overall system.

The result analyzer 130 may have broader functionality beyond defining classes. In some aspects, the result analyzer 130 can output numerical scores or rankings associated with different categories or outcomes; generate probability distributions across multiple possible results; produce continuous value predictions rather than discrete classifications; identify patterns or anomalies in the match results; or trigger specific actions or responses based on the analysis of match results. In some implementations, the result analyzer 130 can aggregate or summarize information from multiple match results; apply post-processing algorithms to refine or contextualize the raw match data; interface with other system components to provide inputs for further processing or decision making; store or log results for later analysis or to inform future determinations; or adapt its determination criteria based on feedback or changing conditions.

FIG. 2 illustrates an example implementation of the first circuit 210 having a crossbar engine 212 (which in some implementations can be a dot product engine). The first circuit 210 in FIG. 2 may be similar to the first circuit 110 described above in relation to FIG. 1.

In some implementations, the first circuit 210 can be configured for processing analog or digital inputs. The first circuit 210 includes the crossbar engine 212, e.g., a DPE engine, and the signal conditioning engine 214. The first circuit 210 can be configured to receive an input vector Xi, perform matrix multiplication as part of the dimensionality reduction on the input, and output a processed feature vector Wi.

In some implementations, the crossbar engine 212 can be configured to implement the matrix multiplication operation and perform dimensionality reduction tasks such as PCA. The crossbar engine 212 can use a crosspoint array of programmable elements to perform such operations efficiently in the analog domain. Such configuration allows for accelerated computation of matrix-vector multiplications, which can accelerate machine learning algorithms.

In some implementations, the signal conditioning engine 214 can be configured to receive the output from the crossbar engine 212, transform such signals, typically from currents to voltages, and prepare the output signals Wi for the next stage of processing (e.g., for input to the ACAM 120). The signal conditioning engine 214 may include one or more TIA for current-to-voltage conversion.

In some implementations, the analog input vector Xi can be input into the first circuit 210. The crossbar engine 212 performs the initial matrix multiplication and dimensionality reduction. The output of the crossbar engine 212 is then processed by the signal conditioning engine 214. In one or more examples, the signal conditioning engine 214 outputs the feature vector Wi based on the input vector Xi, a matrix programmed into the crossbar engine 212, and signal transformations performed by the signal conditioning engine 214.

In some implementations, the crossbar engine 212 may include a DPE array. In some implementations, the DPE array includes a plurality of input electrodes, a plurality of output electrodes, and plurality of programmable elements. DPE array also may be referred to as a programmable crossbar array. In some implementations, the input electrodes are arranged in subsets, e.g., in DPE rows, the output electrodes are arranged in subsets, e.g., in DPE columns. Each programmable element can be positioned at a crosspoint or junction of an input electrode and an output electrode. As input, the DPE array can take a vector of analog signals (on the input electrodes).

In some implementations, the programmable elements may be circuit elements that may have programmable values (e.g., conductances, resistances, and the like). The programmable elements may be non-volatile analog devices, which may be adapted to store one or more bits of data. An example of a programmable element is a memristor, which includes a dielectric layer (e.g., an oxide layer) between two metal layers. When the programmable elements are memristors, the DPE array is a memristor array. Other examples of programmable elements include multi-bit flash memory cells, resistive random-access memory (ReRAM) cells, phase-change random-access memory (PCRAM) cells, magnetoresistive random-access memory (MRAM) cells, electrochemical random-access memory (ECRAM) cells, and/or other suitable programmable elements.

The DPE array may also include other peripheral circuitry associated with the DPE array when used as a storage device. For example, the DPE array may include drivers connected to the input electrodes. An address decoder can be used to select an input electrode and activate a driver corresponding to the selected input electrode. The driver for a selected input electrode can drive a corresponding input electrode with different voltages corresponding to a vector-matrix multiplication or the process of setting resistance values within the programmable elements of the DPE array. Similar driver and decoder circuitry may be included for the output electrodes. Control circuitry may also be used to control application of voltages at the inputs of the DPE array. Input signals to the input electrodes and the output electrodes can be analog signals. The peripheral circuitry above described can be fabricated using semiconductor processing techniques in the same integrated structure or semiconductor die as the DPE array.

In some implementations, the DPE array can include M input electrodes and U output electrodes. As described in further detail below, there are at least two operations that occur during operation of the DPE array. The first operation is to program the programmable elements in the DPE array so as to map the mathematic values in an M×U matrix to the programmable elements for DPE array. The second operation is the dot product or vector-matrix multiplication operation. In this operation, input voltages are applied to the input electrodes and output currents are obtained from the output electrodes, corresponding to the result of multiplying an Mx 1 vector with the M×U matrixes. The input voltages are below the threshold of the programming voltage of the programmable elements so the resistance values of the programmable elements in the DPE array are not changed during the vector-matrix multiplication operation.

As an example, in implementations where the DPE array uses memristors as programmable elements, the following programming process may be used. The DPE array may be programmed to store the M×U matrixes by modifying the conductances of the programmable elements. In some implementations, the conductances of the programmable elements are values corresponding to the M×U matrixes. The conductances of the programmable elements may be modified by imposing a voltage across the programmable elements using the input electrode, the output electrodes, and corresponding voltage drivers. In some implementations, the voltage difference imposed across a programmable element generally determines the resulting conductance of that programmable element. The programming process may be performed row-by-row.

A vector-matrix multiplication may be executed through the DPE array by applying a set of voltages simultaneously along the input electrodes of the DPE array and collecting the currents through the output electrodes. The signal generated on an output electrode is weighted by the corresponding conductance of the programmable elements at the crosspoints of the output electrode with the input electrodes, and that weighted summation is reflected in the current at the output electrode. Thus, the relationship between the voltages at the input electrodes and the currents at the output electrodes is represented by a vector-matrix multiplication of the input vector (e.g., the search vector) with the M×U matrix determined by the conductances of the programmable elements for DPE array.

In some implementations, the crossbar engine 212 performs the initial matrix multiplication in order to perform dimensionality reduction. In some implementations, the current output from the crossbar engine 212 can be converted into voltage with a transimpedence amplifier (TIA) for further processing of the resulting signal. In some implementations, the crossbar engine 212 may accelerate matrix-vector multiplication, which, when used in conjunction with the other components (e.g., the ACAM 120 and the result analyzer 130) of the accelerator 100, may accelerate such tasks as neural networks inference, image processing, optimization, algebraic operations, and the like.

In some implementations, the signal conditioning engine 214 can be represented by a plurality of feedback circuits where each feedback circuit processes a corresponding input current Y₁, Y₂, . . . , Yₙ provided by the crossbar engine 212. Each feedback circuit can include a resistor having a resistance R_{F} where the resistor is coupled in parallel to an inverting circuit. For example, an inverting circuit may be a circuit that takes an input signal and produces an output signal that is the logical opposite of the input signal. In some implementations, the inverting circuit can be configured using amplifying stages, such as an operational amplifier, configured in an inverting setup. In such configuration, the output voltage may be proportional to the negative of the input voltage. In some implementations, an inverting input of the inverting circuit is coupled to the resistor and a non-inverting input of the inverting circuit is coupled to the v_{bias}.

The crossbar engine 212 can receive digital input signals in various forms: binary streams, parallel data buses, serial interfaces, or packetized data (e.g., Ethernet frames). In some implementations, the crossbar engine 212 can process input buffering and synchronization. As an example, digital inputs can be buffered using flip-flops or registers. Clock domain crossing techniques may be employed if the input clock differs from the DPE's internal clock. In some implementations, the crossbar engine 212 can process signals represented in digital formats such as: fixed-point numbers, floating-point numbers, or integer values (depending on the appropriate precision and architecture of the crossbar engine 212).

A circuitry example of the accelerator 100 operating with the digital input can include the signal conditioning engine 214, which can be represented by a plurality of feedback circuits where each feedback circuit processes a corresponding input current Y₁, Y₂, . . . , Yₙ provided by the crossbar engine 212. Each feedback circuit can include a capacitor having a capacitance C where the capacitor is coupled in parallel to an inverting circuit (e.g., an operational amplifier). An inverting input of the inverting circuit is coupled to the capacitor and a non-inverting input of the inverting circuit is coupled to the v_{bias}. The integrator stage can be performed by a current mirror for bit slicing. In some implementations, the input current signals Y₁, Y₂, . . . , Yₙ are provided to the current mirror that is coupled to the inverting input of the inverting circuit.

FIG. 3 illustrates a configuration of a first circuit 310, which can be an autoencoder, according to some implementations. FIG. 3 illustrates a diagram of a first circuit 310, according to another implementation of the present disclosure. The first circuit 310 in FIG. 3 may be similar to the first circuits 110 and 210 described above in relation to FIGS. 1 and 2. In some implementations, a circuitry example of the accelerator 100 can include the crossbar engines 316 and 318 (e.g., the DPEs), the signal conditioning and NLP engine 317, which can be a rectified linear unit, and the ACAM 120 operating with the analog input, according to some implementations.

FIG. 3 illustrates a configuration of the first circuit 310 configured for analog and digital inputs. In some implementations, the first circuit 310 can include two or more crossbar engines 316 and 318 and additional processing elements, such as the signal conditioning and NLP engine 317 and the converter 319. In some implementations, the accelerator 100 can include an ACAM 120 and a result analyzer 130. FIG. 3 illustrates an example implementation of a first circuit 310 of the accelerator 100, according to some implementations.

For example, the signal conditioning and nonlinear transformation engine 317 of FIG. 3 can be represented by a plurality of feedback circuits where each feedback circuit processes a corresponding current signal Y₁, Y₂, . . . , Yₙ provided by the crossbar engine 316. Each feedback circuit can include two inverting circuits (e.g., operational amplifiers). In some implementations, the feedback circuit can include a resistor having a resistance R_{F}. In some implementations, the resistor is coupled in parallel to the first inverting circuit and to a switch where the switch is activated by an output of the second inverting circuit.

In some implementations the output of the first inverting circuit outputs the signal current Pᵢ. An inverting input of the first inverting circuit receives the signal current Yᵢ and is coupled to the resistor and to the switch. In some implementations, a non-inverting input of the first inverting circuit is coupled, for example, to the v_{bias}. An inverting input of the second inverting circuit is coupled to the resistor, switch, and output line of the signal Pᵢ. In some implementations, a non-inverting input of the second inverting circuit is coupled to the v_{bias}.

In some implementations, when the accelerator 100 is implemented, the analog input signal is provided to the accelerator 100 and the digital output is output by the accelerator 100. The conversions for DAC and ADC are not performed during such implementations of the accelerator 100.

In some implementations, the crossbar engine 316 transforms digital inputs X₁, X₂, . . . , Xₘ to a high dimensional space. For example, the crossbar engine 316 can transform the digital inputs X₁, X₂, . . . , Xₘ to current signals Y₁, Y₂, . . . , Yₙ. In some implementations, the crossbar engine 316 can output current signals Y₁, Y₂, . . . , Yₙ, where n can be equal or not equal to m. For example, n can be greater than m. In some implementations, the signal conditioning and nonlinear transformation engine 317, performing functions of the autoencoder, transforms input currents or charges Y₁, Y₂, . . . , Yₙ to voltages Q₁, Q₂, . . . , Qⱼ. The crossbar engine 318 transforms signals Q₁, Q₂, . . . , Qⱼ to a feature vector Wi with features W₁, W₂, . . . , Wₚ. The W vector signals W₁, W₂, . . . , Wₚ can be calculated using Equation (1) with input vector signals X₁, X₂, . . . , Xₘ, conductance matrix M, feedback resistance R_{F}, and bias voltage v_{bias}.

In some implementations, the first circuit 310 uses converter 319 to convert signals from the crossbar engine 318 into feature vector Wi. In some implementations, the ACAM 120 transforms signals W₁, W₂, . . . , Wₚ to output signals Z₁, Z₂, . . . , Zₖ. The ACAM 120 can output signals Z₁, Z₂, . . . , Zₖ, using, for example, a decision tree for classification. The transfer function ƒ_{ACAM} of the ACAM 120 can be defined by Equation (2) for calculating Zi, where T_{low,i} and T_{high,i} are the sets of thresholds that a given feature value is compared against in a cell of the ACAM 120 as part of implementing the decision tree in the ACAM 120. The SRAM in the result analyzer 130 can identify winning leaves defining the classified output. The accelerator 100 processes digital input signals Xi without DAC and ADC conversions.

A circuitry example of the accelerator 100 can have crossbar engines 316, 318 (e.g., the DPEs), the signal conditioning and NLP engine 317, which can be a rectified linear unit, the ACAM 120 operating with the digital input, and inverting circuits, according to some implementations. The integrator stage can be performed by a current mirror for bit slicing where the input current signals Y₁, Y₂, . . . , Yₙ are provided to the current mirror that is coupled to the inverting input of the third inverting circuit.

In some implementations, the signal conditioning and nonlinear transformation engine 317 of FIG. 3 can be represented by a plurality of feedback circuits where each feedback circuit processes a corresponding current signal Y₁, Y₂, . . . , Yₙ provided by the crossbar engine 316. Each feedback circuit can include two inverting circuits (e.g., operational amplifiers), for example, the third and fourth inverting circuits. In some implementations, the feedback circuit can include a capacitor having a capacitance C. In some implementations, the capacitor is coupled in parallel to the third inverting circuit and to a switch, where the switch is activated by an output of the fourth inverting circuit.

In some implementations, the output of the third inverting circuit outputs the signal Pᵢ. An inverting input of the third inverting circuit receives the signal current Yᵢ and is coupled to the capacitor and the switch. In some implementations, a non-inverting input of the third inverting circuit is coupled to the v_{bias}. An inverting input of the fourth inverting circuit is coupled to the capacitor, switch, and the output line of the signal current Pᵢ. In some implementations, a non-inverting input of the fourth inverting circuit is coupled to the v_{bias}.

In some implementations, when the accelerator 100 is implemented, the digital input signal is provided to the accelerator 100 and the digital output is output by the accelerator 100. The conversions for DAC and ADC are not performed during such implementations of the accelerator 100.

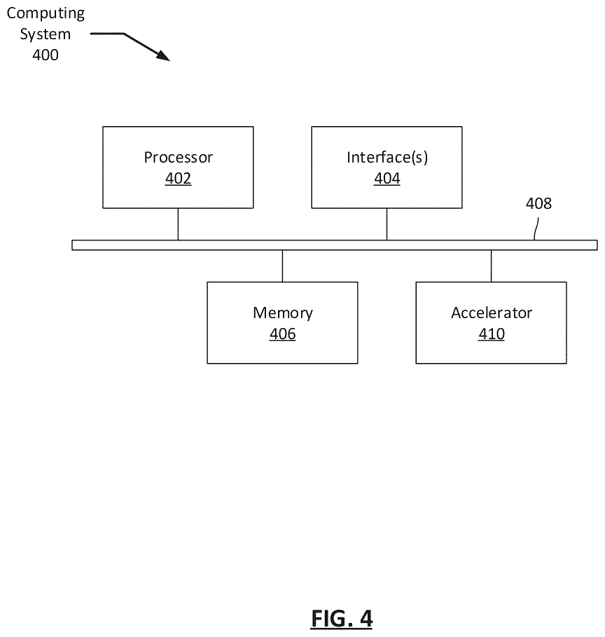

FIG. 4 is a block diagram of an example computing system 400, that can be used to accelerate the multi-staged machine learning pipelines without data converter (e.g., ADC, DAC) as previously described. In some implementations, the accelerator 410 illustrated in FIG. 4 may be an implementation of the accelerator 100 described above in relation to FIGS. 1, 2, and 3. The computing system 400 may be implemented in an electronic device. Examples of electronic devices include servers, desktop computers, laptop computers, mobile devices, gaming systems, and the like.

The computing system 400 may be utilized in any data processing scenario, including stand-alone hardware, mobile applications, or combinations thereof. Further, the computing system 400 may be used in a computing network, such as a public cloud network, a private cloud network, a hybrid cloud network, other forms of networks, or combinations thereof. In one example, the methods provided by the computing system 400 are provided as a service over a network by, for example, a third party. The computing system 400 may be implemented on one or more hardware platforms, in which the modules in the system can be executed on one or more platforms. Such modules can run on various forms of cloud technologies and hybrid cloud technologies or be offered as a Software-as-a-Service that can be implemented on or off a cloud.

To achieve its desired functionality, the computing system 400 includes various hardware components. These hardware components may include a processor 402, one or more interface(s) 404, a memory 406, and an accelerator 410. The hardware components may be interconnected through a number of busses and/or network connections. In one example, the processor 402, the interface(s) 404, the memory 406, and the accelerator 410 may be communicatively coupled via a bus 408.

The processor 402 retrieves executable code from the memory 406 and executes the executable code. The executable code may, when executed by the processor 402, cause the processor 402 to implement any functionality described herein. The processor 402 may be a microprocessor, an application-specific integrated circuit, a microcontroller, or the like.

The interface(s) 404 enable the processor 402 to interface with various other hardware elements, external and internal to the computing system 400. For example, the interface(s) 404 may include interface(s) to input/output devices, such as, for example, a display device, a mouse, a keyboard, etc. The interface(s) 404 may include interface(s) to an external storage device, or to a number of network devices, such as servers, switches, and routers, client devices, other types of computing devices, and combinations thereof.

The memory 406 may include various types of memory modules, including volatile and nonvolatile memory. For example, the memory 406 may include Random Access Memory (RAM), Read Only Memory (ROM), a Hard Disk Drive (HDD), or the like. The memory 406 may include a non-transitory computer readable medium that stores instructions for execution by the processor 402. One or more modules within the computing system 400 may be partially or wholly embodied as software and/or hardware for performing any functionality described herein. Different types of memory may be used for different data storage needs. For example, in certain examples the processor 402 may boot from ROM, maintain nonvolatile storage in an HDD, and execute program code stored in RAM.

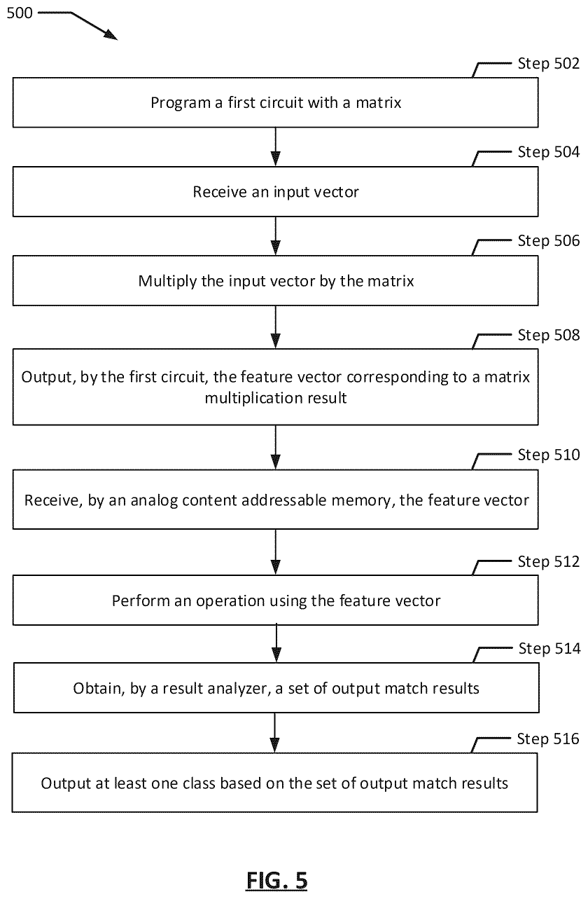

FIG. 5 is a flowchart of an example method 500. More specifically, FIG. 5 is a diagram of an acceleration method 500, according to some implementations. In some implementations, one or more process blocks of FIG. 5 may be performed by the accelerator 100 or 410 or components therein, such as the first circuit (e.g., 110, 210, and/or 310), the ACAM 120, and/or the result analyzer 130. The acceleration method 500 may be performed by the accelerator 100 or 410 as part of processing acceleration of the multi-staged machine learning pipelines without data converter. For example, the acceleration method 500 may be performed as part of an acceleration operation for accelerating machine learning algorithms using DPEs and ACAMs.

As shown in FIG. 5 (block 502), method 500 may include programming a first circuit, (e.g., the first circuit examples 110, 210, and/or 310 as shown in FIGS. 1, 2, 3, and discussed above) with a matrix. The processor 402 can perform a step 502 of programming a first circuit (e.g., 110, 210, and/or 310) with a DPE matrix (e.g., the matrix encoded into programmable elements of the DPE).

In some implementations, method 500 may include receiving, by a first circuit (e.g., 110, 210, and/or 310), an input vector Xi (block 504). In some implementations, the first circuit (e.g., 110, 210, and/or 310) can include, e.g., the crossbar engine 212, 316. In some implementations, the input vector Xi comprises a first set of values, which can be either analog or digital signals, or a combination thereof. In some implementations with multiple crossbar engines, each crossbar engine may receive a portion of the input vector Xi or a transformed version of it. In some implementations, the first circuit (e.g., 110, 210, and/or 310) may receive analog signals representing the input vector Xi. In some implementations, the first circuit (e.g., 110, 210, and/or 310) may receive digital signals, which could be in the form of binary streams, parallel data buses, serial interfaces, or packetized data.

As further shown in FIG. 5, method 500 may include performing, by the first circuit (e.g., 110, 210, and/or 310), a matrix multiplication by multiplying the input vector Xi by the matrix to obtain a matrix multiplication result where the matrix multiplication result corresponds to a feature vector Wi (block 506). For example, the accelerator 100 or 410 may perform, by the first circuit (e.g., 110, 210, and/or 310), a matrix multiplication by multiplying the input vector Xi by the matrix to obtain a matrix multiplication result where the matrix multiplication result corresponds to a feature vector Wi as described above.

In some implementations, for the PCA-based implementation (e.g., as shown in FIG. 2), the first circuit 210 performs a matrix multiplication by multiplying the input vector Xi by the programmed matrix in the crossbar engine 212. In some implementations, the matrix can be, e.g., the crossbar matrix of conductances. This calculation may include performing a transformation operation (previously described for Equation (1)) on the input vector X. The previously described first circuit (e.g., 110, 210, and/or 310) of the accelerator 410 may be used by the processor 402 to calculate a feature matrix W (previously described for Equation (1)) for the input vector X. At least some of this calculation may be performed in the analog or digital domain, at least in part, using the accelerator 410 of FIG. 4.

In some implementations, for the PCA-based implementation (e.g., as shown in FIG. 2), the result of the matrix-vector multiplication performed in step 506 corresponds to the feature vector Wi, which represents the dimensionality-reduced data. In some implementations, for the autoencoder implementation (e.g., as shown in FIG. 3), the method 500 involves multiple stages. As an example, the first crossbar engine 316 multiplies the input vector Xi by the matrix programmed into the first crossbar engine 316 (e.g., the DPE).

In some implementations, for the autoencoder implementation (e.g., as shown in FIG. 3), the resulting output from the operation(s) performed in step 506 undergoes processing in the signal conditioning and NLP engine 317. In some implementations, the processed output is then multiplied by another matrix in the second crossbar engine 318. In some implementations, the output of the above described multi-stage process corresponds to the feature vector Wi. In some implementations, the matrix multiplication operations are performed in the analog domain, leveraging the efficiency of the crossbar architecture.

As shown in FIG. 5, method 500 may include outputting, by the first circuit 110, 210, 310, the matrix multiplication result corresponding to the feature vector Wi (block 508). For example, the accelerator 100 or 410 may output, by the first circuit (e.g., 110, 210, and/or 310), the feature vector Wi as described above. In some implementations, the feature vector Wi represents the transformed and typically dimensionality-reduced version of the input data vector Xi.

As further shown in FIG. 5, method 500 may include receiving, by the ACAM 120, the feature vector Wi (block 510). In some implementations, the feature vector Wi corresponding to the matrix multiplication result can be received by the ACAM 120.

As shown in FIG. 5, method 500 may include performing, by the ACAM 120, an operation using the feature vector Wi (block 512). The processor 402 performs a step 512 of performing an operation using the feature vector Wi and a transfer function ƒ_{ACAM} corresponding to a decision tree.

As further shown in FIG. 5, method 500 may include obtaining, by the result analyzer 130, a set of output match results Zi (block 514). The processor 402 performs a step 514 of obtaining a set of output match results Zi. In some implementations, the result analyzer 130 can receive the set of output match results Zi. For example, accelerator 100 or 410 may obtain, by the result analyzer 130, a set of output match results Zi as described above.

As also shown in FIG. 5, method 500 may include outputting by the result analyzer 130 at least one class based on the set of output match results Zi (block 516). In some implementations, the result analyzer 130 can be a class determiner. The processor 402 performs a step 516 of outputting at least one class based on the set of output match results Zi. In some implementations, the result analyzer 130 can output at least one class based on the set of output match results Zi. For example, accelerator 100 or 410 may output by the result analyzer 130 at least one class based on the set of output match results Zi as described above.

Although FIG. 5 shows example blocks of method 500, in some implementations, method 500 may include additional blocks, fewer blocks, different blocks, or differently arranged blocks than those depicted in FIG. 5. Additionally, or alternatively, two or more of the blocks of method 500 may be performed in parallel.

In one or more examples, using implementations of an accelerator (e.g., the accelerator 100 shown in FIG. 1, the accelerator 410 shown in FIG. 4) may achieve advantages when used for executing machine learning algorithms (e.g., for classification, inference, and the like). As an example, data is often obtained in an analog form, and converted to a digital form before being used as an input for a machine learning algorithm. The data may be further converted between analog and digital forms as needed in order to execute the machine learning algorithm. However, using an accelerator as described herein, an input vector to the accelerator may be either an input vector of analog values or an input vector of digital values, and execution of the machine learning algorithm using the accelerator may be performed using the components discussed herein without the need to use ADCs or DACs, which may, for example, consume large amounts of power, space, and the like. Thus, in one or more examples, use of an accelerator (e.g., the accelerator 100 shown in FIG. 1, the accelerator 410 shown in FIG. 4) may provide lower power consumption, lower latency, improved parallelization of operations, and/or other advantages.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. Steps may operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A device comprising:
a first circuit programmed with a matrix and configured to:
receive an input vector comprising a first set of values;
perform a matrix multiplication by multiplying the input vector by the matrix to obtain a matrix multiplication result; and
output the matrix multiplication result, wherein the matrix multiplication result corresponds to a feature vector;
an analog content addressable memory (ACAM) configured to:
receive the feature vector; and
perform an operation using the feature vector to obtain a set of output match results; and
a result analyzer configured to output at least one machine learning algorithm result based on the set of output match results.

2. The device of claim 1, wherein the matrix multiplication is performed using a dot product engine (DPE) of the first circuit.

3. The device of claim 1, wherein the first circuit comprises one or more of a signal conditioning engine or a rectified linear unit.

4. The device of claim 1, wherein the first circuit is further configured to perform one or more of autoencoding or a principal component analysis.

5. The device of claim 1, wherein the machine learning algorithm result comprises one or more classes.

6. The device of claim 1, wherein:
the ACAM is configured to perform the operation using the feature vector and a transfer function corresponding to a decision tree, wherein the transfer function of the ACAM is defined at least partially by thresholds.

7. The device of claim 1, wherein the input vector comprises analog input signals.

8. The device of claim 1, wherein the device further comprises a digital to analog converter (DAC) configured to receive digital input signals and output the input vector.

9. The device of claim 1, wherein the first circuit further comprises a transimpedance amplifier for converting current signals to voltage signals.

10. The device of claim 1, wherein the first circuit is configured to perform matrix-vector multiplication in an analog domain by multiplying the input vector comprising a first set of analog values and the matrix comprising a second set of analog values.

11. The device of claim 1, wherein the ACAM is configured to perform classification tasks without analog-to-digital conversion.

12. A method comprising:
receiving, by a first circuit programmed with a matrix, an input vector, the input vector comprising a first set of values;
performing, by the first circuit, a matrix multiplication by multiplying the input vector by the matrix to obtain a matrix multiplication result, wherein the matrix multiplication result corresponds to a feature vector;
outputting, by the first circuit, the feature vector;
receiving, by an analog content addressable memory (ACAM), the feature vector;
performing, by the ACAM, an operation using the feature vector;
obtaining, by the ACAM, a set of output match results; and
outputting, by a result analyzer, at least one machine learning algorithm result based on the set of output match results.

13. The method of claim 12, wherein the matrix multiplication is performed by a dot product engine.

14. The method of claim 12, wherein the first circuit comprises one or more of a signal conditioning engine or a rectified linear unit.

15. The method of claim 12, wherein the first circuit is further configured to perform one or more of autoencoding or a principal component analysis.

16. The method of claim 12, wherein the ACAM is configured to perform at least a portion of a decision tree classification.

17. The method of claim 12, wherein the ACAM is configured to perform classification tasks without analog-to-digital conversion.

18. A system for accelerating machine learning pipelines, the system comprising:
one or more processors;
memory; and
a device comprising:
a first circuit programmed, by the one or more processors, with a matrix and configured to:
receive, by a first crossbar engine, an input vector comprising a first set of values;
perform, by the first crossbar engine, a matrix multiplication by multiplying the input vector by the matrix to obtain a matrix multiplication result; and
output, by the first crossbar engine, the matrix multiplication result, wherein the matrix multiplication result corresponds to a feature vector;
an analog content addressable memory (ACAM) configured to:
receive the feature vector; and
perform an operation using the feature vector to obtain a set of output match results; and
a result analyzer configured to output at least one machine learning algorithm result based on the set of output match results,
wherein the one or more processors are configured to execute instructions stored in the memory to interpret the at least one machine learning algorithm result output by the result analyzer.

19. The system of claim 18, wherein the matrix multiplication is performed using a dot product engine of the first circuit.

20. The system of claim 18, wherein the first circuit is further configured to perform one or more of autoencoding or a principal component analysis.
